(19) United States
(12) Patent Application Publication
(10) Pub. No.: US 2024/0395159 A1
(43) Pub. Date: Nov. 28, 2024

(54) METHOD FOR GENERATING AND DEPLOYING AN ORGANIZATIONAL KNOWLEDGE GRAPH

(71) Applicant: Skale Education Inc. (d.b.a. Upduo), San Francisco, CA (US)

(72) Inventors: Benjamin Min-Jia Chang, San Francisco, CA (US); Wei-Yang Sun, San Francisco, CA (US); Quinn Hagstrom Freedman, Bellingham, WA (US); Daniel Douglas Eloff, Vancouver (CA); Michael Scott Mendelson, Truckee, CA (US)

(21) Appl. No.: 18/674,157

(22) Filed: May 24, 2024

Related U.S. Application Data
(60) Provisional application No. 63/468,874, filed on May 25, 2023.

(51) Int. Cl. G09B 5/06; G06F 40/279; G06F 40/35

(52) U.S. Cl. CPC G09B 5/065; G06F 40/279; G06F 40/35

(57) ABSTRACT

A method includes: accessing language concepts representing a discussion between a pair of users; based on the language concepts, extracting a first insight; calculating a set of distances between the first insight and stored insights represented in nodes contained in a knowledge graph; identifying a second node, in the nodes, representing a second insight associated with a shortest distance, in the set of distances, to the first insight; characterizing a first specificity of the first insight; accessing a second specificity of the second insight; in response to the first specificity exceeding the second specificity, generating a proposed node populated with the first insight and descendent from the second node in the knowledge graph; prompting a user to confirm the proposed node; and, in response to receiving a confirmation of the proposed node, storing the proposed node as a first node in the knowledge graph.

### CROSS-REFERENCE TO RELATED APPLICATIONS

This application claims the benefit of U.S. Provisional Application No. 63/468,874, filed on 25 May 2023, which is incorporated in its entirety by this reference.

### TECHNICAL FIELD

This invention relates generally to the field of educational systems and, more specifically, to a new and useful method for generating and deploying an organizational knowledge graph in the field of educational systems.

### BRIEF DESCRIPTION OF THE FIGURES

FIG. 1 is a flowchart representation of a method;

FIG. 2 is a flowchart representation of a variation of the method;

FIG. 3 is a flowchart representation of a variation of the method;

FIG. 4 is a flowchart representation of a variation of the method;

FIG. 5 is a flowchart representation of a variation of the method;

FIG. 6 is a flowchart representation of a variation of the method; and

FIG. 7 is a flowchart representation of a variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

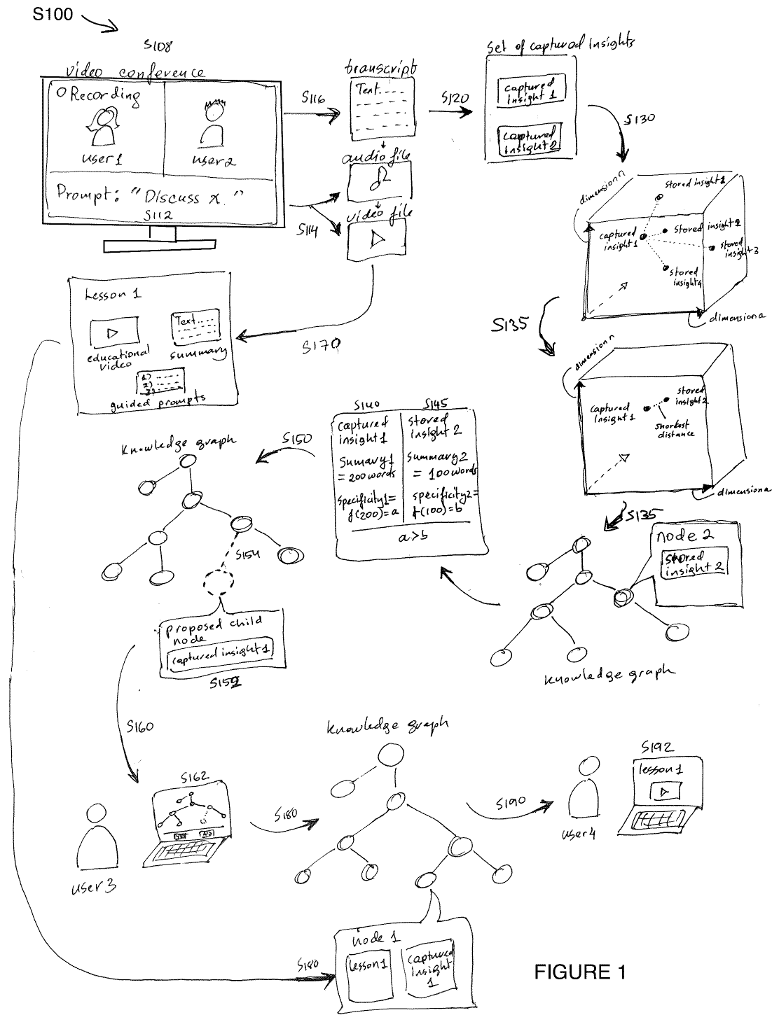

As shown in FIGS. 1-7, a method S100 includes, during a first time period: initiating a first video conference between a first user and a second user in Block S108; serving a first prompt to the first user and the second user in Block S112; and recording a first audio file and a first video file of the first video conference in Block S114.

The method S100 also includes: generating a first transcript of the first audio file in Block S116; based on the first transcript, extracting a first captured insight representing a first unit of knowledge communicated between the first user and the second user during the first video conference in Block S120; calculating a first set of distances between the first captured insight and a set of stored insights represented in a set of nodes contained in a knowledge graph in Block S130; identifying a second node, in the set of nodes in the knowledge graph, representing a second stored insight associated with a shortest distance, in the first set of distances, to the first captured insight in Block S135; characterizing a first specificity score of the first captured insight in Block S140; and accessing a second specificity score of the second stored insight represented by the second node in Block S145.

The method S100 also includes, in response to the first specificity score exceeding the second specificity score: generating a proposed child node in Block S150; populating the proposed child node with the first captured insight in Block S152; defining the proposed child node as descendent from the second node in the knowledge graph in Block S154; serving a first visual representation of the proposed child node in the knowledge graph to a third user in Block S160; and prompting the third user to confirm the proposed child node in Block S162.

The method S100 further includes: in response to receiving a first confirmation of the proposed child node from the third user generating a lesson based on the first captured insight, the first transcript, and the first video file in Block S170 and storing the proposed child node as a first node, descendent from the second node and populated with the lesson, in the knowledge graph in Block S180; and, during a second time period succeeding the first time period, assigning the first node to a fourth user in Block S190 and serving the lesson, from the first node, to the fourth user in Block S192.

### 1.1 Variation: Prompting Additional Discussion for an Intermediate Node

In one variation, the method S100 includes: during a first time period, serving a first prompt to a first user and a second user, the first prompt associated with a first node in a knowledge graph in Block S112; accessing a first set of language concepts representing a discussion between the first user and the second user responsive to the first prompt in Block S118; based on the first set of language concepts, extracting a first captured insight representing a first unit of knowledge communicated between the first user and the second user in response to the first prompt in Block S120; calculating a first set of distances between the first captured insight and stored insights represented in a set of nodes contained in the knowledge graph in Block S130; identifying a second node, in the set of nodes in the knowledge graph, representing a second stored insight associated with a shortest distance, in the first set of distances, to the first captured insight in Block S135; characterizing a first specificity score of the first captured insight in Block S140; accessing a second specificity score of the second stored insight represented by the second node in Block S145; and, in response to the first specificity score exceeding the second specificity score, generating a first node descendent from the second node in the knowledge graph and populated with the first captured insight in Block S180.

The method S100 further includes, in response to the shortest distance exceeding a threshold: based on the first captured insight and the second stored insight, generating a second prompt configured to elicit sharing of knowledge linking the second stored insight to the first captured insight in Block S110; during a second time period succeeding the first time period, serving the second prompt to a third user in Block S112 and accessing a second set of language concepts representing a response of the third user to the second prompt in Block S118; based on the second set of language concepts, extracting a second captured insight in Block S120; and inserting an intermediate node, containing the second captured insight, into the knowledge graph between the first node and the second node in Block S180.

### 1.1 Variation: Adding a Proposed Child Node to the Knowledge Graph

In one variation, the method S100 includes: during a first time period, accessing a set of language concepts representing a discussion between a first user and a second user responsive to a first prompt in Block S118; based on the set of language concepts, extracting a first captured insight representing a first unit of knowledge communicated between the first user and the second user responsive to the first prompt in Block S120; calculating a first set of distances between the first captured insight and stored insights represented in a set of nodes contained in a knowledge graph in Block S130; identifying a second node, in the set of nodes in the knowledge graph, representing a second stored insight associated with a shortest distance, in the first set of distances, to the first captured insight in Block S135; characterizing a first specificity score of the first captured insight in Block S140; accessing a second specificity score of the second stored insight represented by the second node in Block S145; and, in response to the first specificity score exceeding the second specificity score, generating a proposed child node in Block S150, populating the proposed child node with the first captured insight in Block S152, defining the proposed child node as descendent from the second node in the knowledge graph in Block S154, serving a visual representation of the proposed child node in the knowledge graph to a third user in Block S160, and prompting the third user to confirm the proposed child node in Block S162. The method S100 further includes, in response to receiving a confirmation of the proposed child node from the third user, storing the proposed child node as a first node, descendent from the second node, in the knowledge graph in Block S180.

### 2. Applications

Generally, as shown in FIGS. 1-7, the computer system can generate a knowledge graph representing aggregate knowledge held by a population of users within an organization, such as within a local or distributed corporate or education environment.

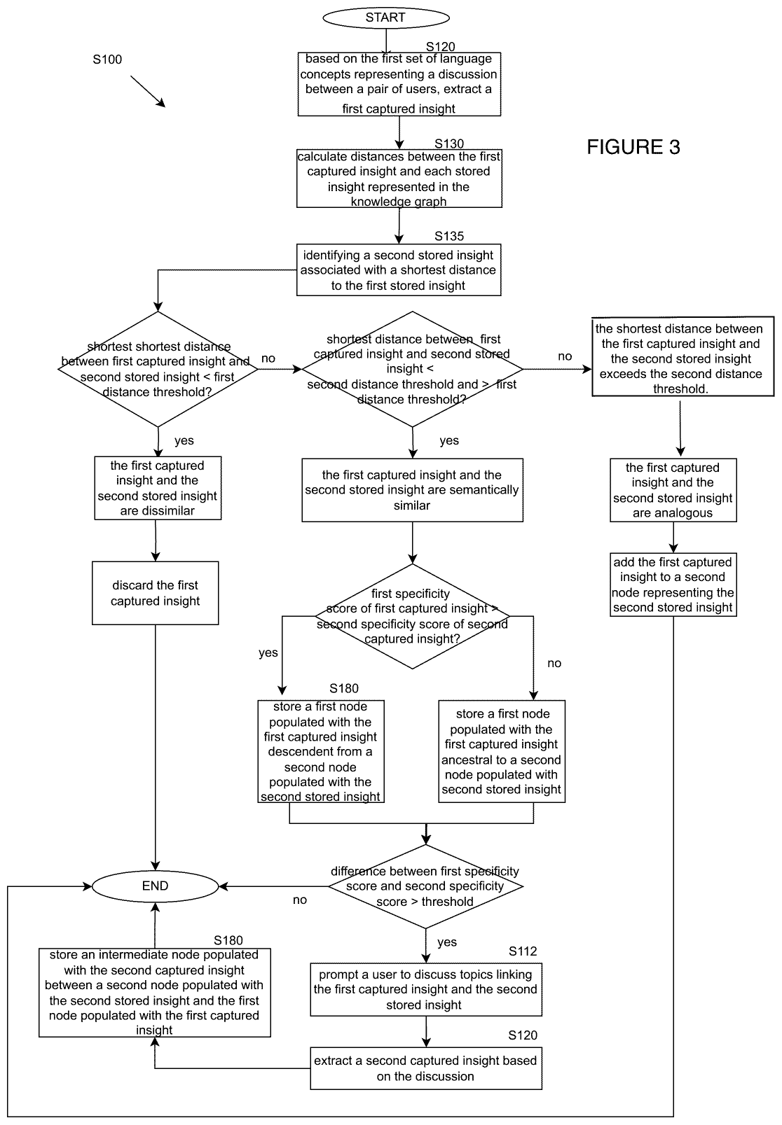

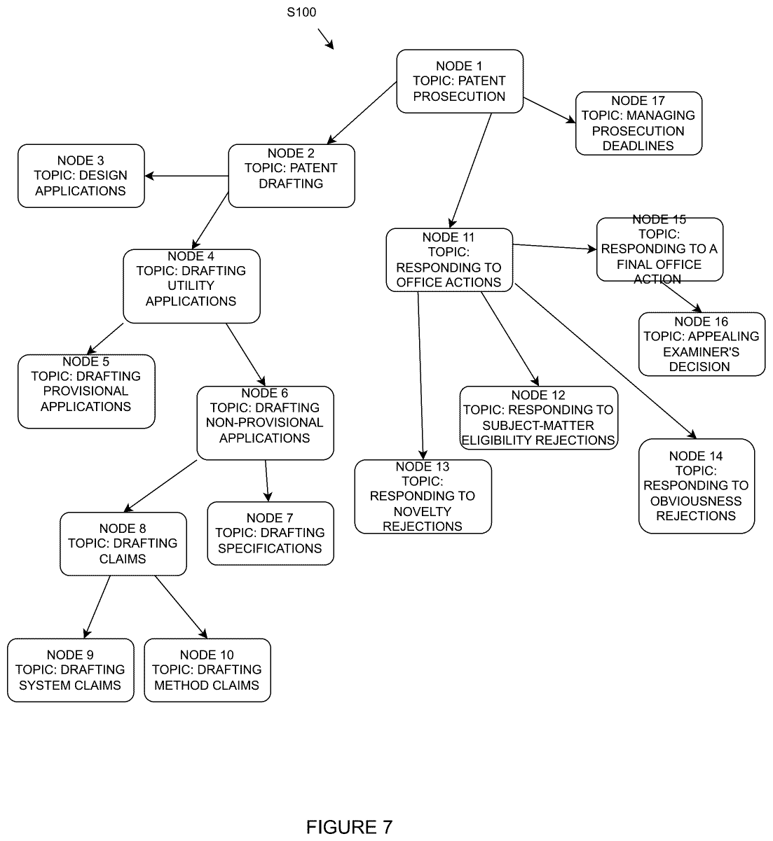

In particular, the computer system can generate the knowledge graph representing organizational knowledge by: accessing audio and/or video files of a discussion between users within the organization responsive to a first prompt contained in an existing node in the knowledge graph; extracting language concepts from the audio and/or video files; grouping these language concepts into discrete insights (e.g., pieces of information, units of knowledge, protocols, ideas, concepts, facts); isolating a first set of these insights directed to the first prompt based on proximity of language concepts in these insights and in the first prompt; populating (or updating) the node with this first set of insights; isolating a second set of these insights containing language concepts related to but distant from the first prompt; transforming language concepts in the second set of insights into a second prompt; initializing a proposed node populated with the second prompt and the second set of insights; locating the proposed node in the knowledge graph (as shown in FIG. 7) based on proximity of language concepts in the prompts and insights contained in the node and the proposed node; prompting an administrator to review and confirm the second prompt, the second set of insights, and/or the second location of the proposed node in the knowledge graph; and storing the proposed node as a second node in the knowledge graph if confirmed by the administrator, as shown in FIG. 3. The computer system can execute this process based on multiple groups of insights detected in a single discussion between users within the organization and/or based on many discussions between many users within the organization responsive to prompts contained in nodes in the knowledge graph.

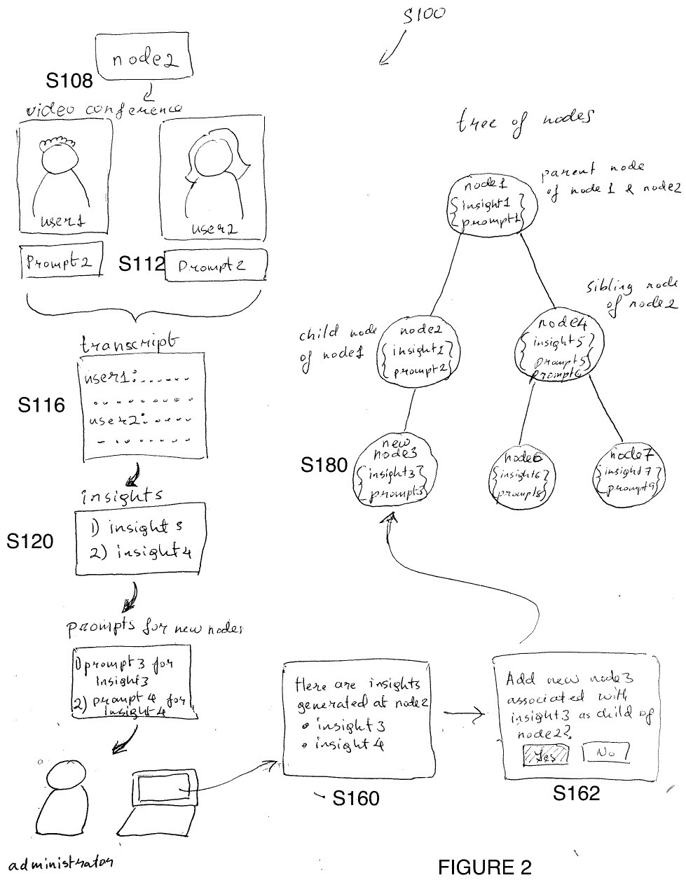

More specifically, the computer system can: store prompts related to organizational knowledge within nodes in the knowledge graph; extract insights from conversations between users within the organization responsive to these prompts; populate nodes in the knowledge graph with insights extracted from these conversations and containing language concepts proximal the prompts corresponding to these nodes; and automatically create or propose new nodes within the knowledge graph based on insights extracted from these conversations and containing language concepts more distant from extant nodes in the knowledge graph, as shown in FIGS. 1 and 2.

For example, the computer system can: implement an autonomous transcription tool to convert an audio recording of a conversation into a transcript; implement a large language model to extract language concepts from the transcript, group these language concepts into insights, and transpose insights and prompts; and implement a word vector cube or the large language model to characterize a distance (or a proximity metric) between language concepts, insights, and/or prompts within one node, across multiple existing nodes, or across multiple proposed nodes within the knowledge graph.

In this example, an administrator within the organization can initialize the knowledge graph with one or more nodes, each containing one prompt only. As shown in FIGS. 1 and 2, The computer system can then: selectively assign a pair of users within the organization to one of these incomplete nodes in the knowledge graph; prompt these users to share their knowledge related to the prompt contained within this node; retrieve an audio recording, transcript, or other record of this conversation; extract insights from this record; selectively populate this node with insights closely related to the prompt; and autonomously initialize or propose new nodes-containing new prompts and/or related insights-extracted from the conversation and sufficiently distant from the original prompt in the node assigned to these users.

Furthermore, the computer system can: selectively assign a pair of users within the organization to a node (i.e., a node containing a prompt and insights extracted from past conversations between users within the organization) in the knowledge graph; and prompt these users to respond to a prompt contained within this node. Thus, the computer system can enable these users to both: access existing organizational knowledge related to the prompt within the node; and to share their knowledge related to the prompt and insights stored in the node, which may include broader, more specific, or updated information related to the node or other nodes in the knowledge graph.

Therefore, by assigning a user to a node in the knowledge graph, the computer system can expose the user to insights extracted from past conversations between other users in the organization. The computer system can further assign the user to many or all nodes in the knowledge graph over time, thereby enabling the user to access organizational knowledge held across the entire user population within the organization. The computer system can therefore enable the organization to build and deploy continuous, scalable, and current peer-to-peer teaching and support across the user population, such as employees within an in-person, remote or distributed company, or local or remote students within an educational setting.

Generally, computer system can initiate a video conference and present a prompt for discussion to a pair of users from the user population. However, computer system can also initiate a video conference and present the prompt for discussion to a single user or a group of users from the user population.

Generally, the computer system can extract insights from the first discussion based on the transcript of an audio file of the discussion. However, in addition to extracting insights, the computer system can also extract other information, such as discussion quality or a user's level of understanding of the insights, based on transcript of the audio file of the discussion. For example, based on the amount or quality or information provided by a user and recorded in the transcript, the computer system can identify the user as an expert user or a domain expert.

Generally, as implemented herein, “video conference” can include a variety of communication media, such as including: voice calls; instant messaging chats; augmented reality, virtual reality, or extended reality experiences; avatar interactions; etc. If, for example, during the video conference, the users communicate via text-based messages instead of audio, the computer system can record the text-based messages sent by the users instead of recording an audio file of the verbal conversation between the users.

Generally, as implemented herein, “prompt” refers to a text or an audio recording of a question or a statement intended to initiate a conversation. However, the prompt can also include other types of media such as an image or a video created by generative artificial intelligence. Generally, during the video conference, the computer system can present a prompt (e.g., a single prompt) to a pair of users. However, during the video conference, the computer system can also present more than one prompt to the pair of users. For example, the computer system can present a first prompt to the first user and present a second prompt (e.g., a new prompt different from, but related to, the first prompt) to a second user.

### 2.1 Example

For example, a computer system can: initiate a first video conference between a first user and a second user and during the first video conference; and present a first prompt for discussion to the first user and the second user, the first prompt associated with an initial node. For example, the computer system can provide a pair of real estate agents with a prompt to “discuss strategies for hosting a successful open-house event at a property.” During the video conference, the two users may take turns sharing ideas and discussing the prompt. During the video conference, the computer system can record an audio file and a video file of the first video conference. Following the video conference, the computer system can: generate a transcript of the audio file; and, based on the transcript of the first audio file, extract a set of captured insights of the discussion between the first user and the second user, the set of captured insights representing units of knowledge shared by the first user and/or the second user during the first video conference.

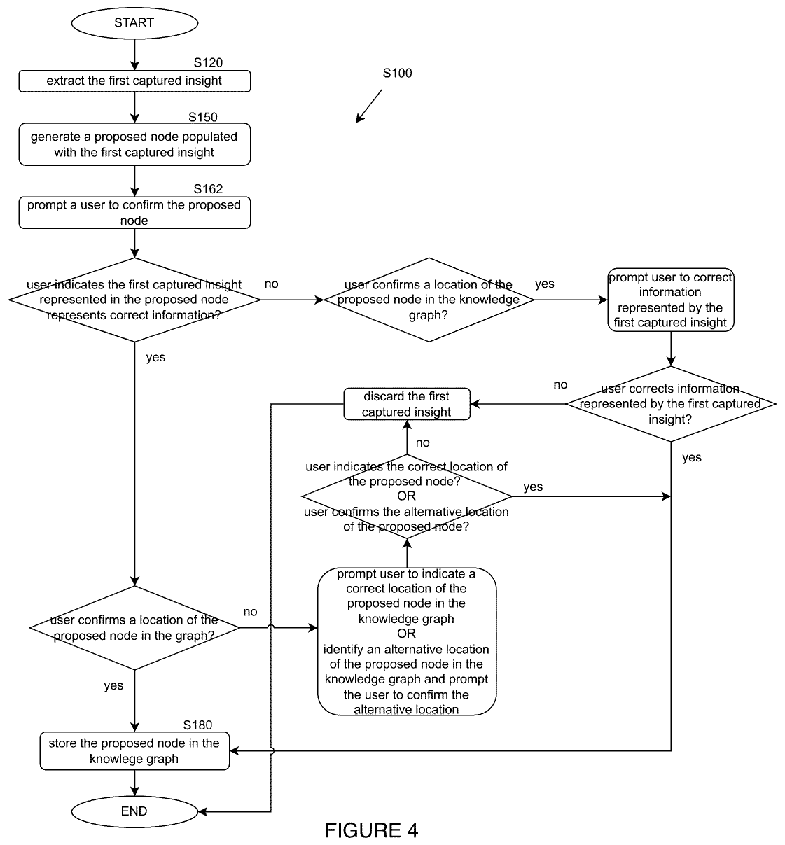

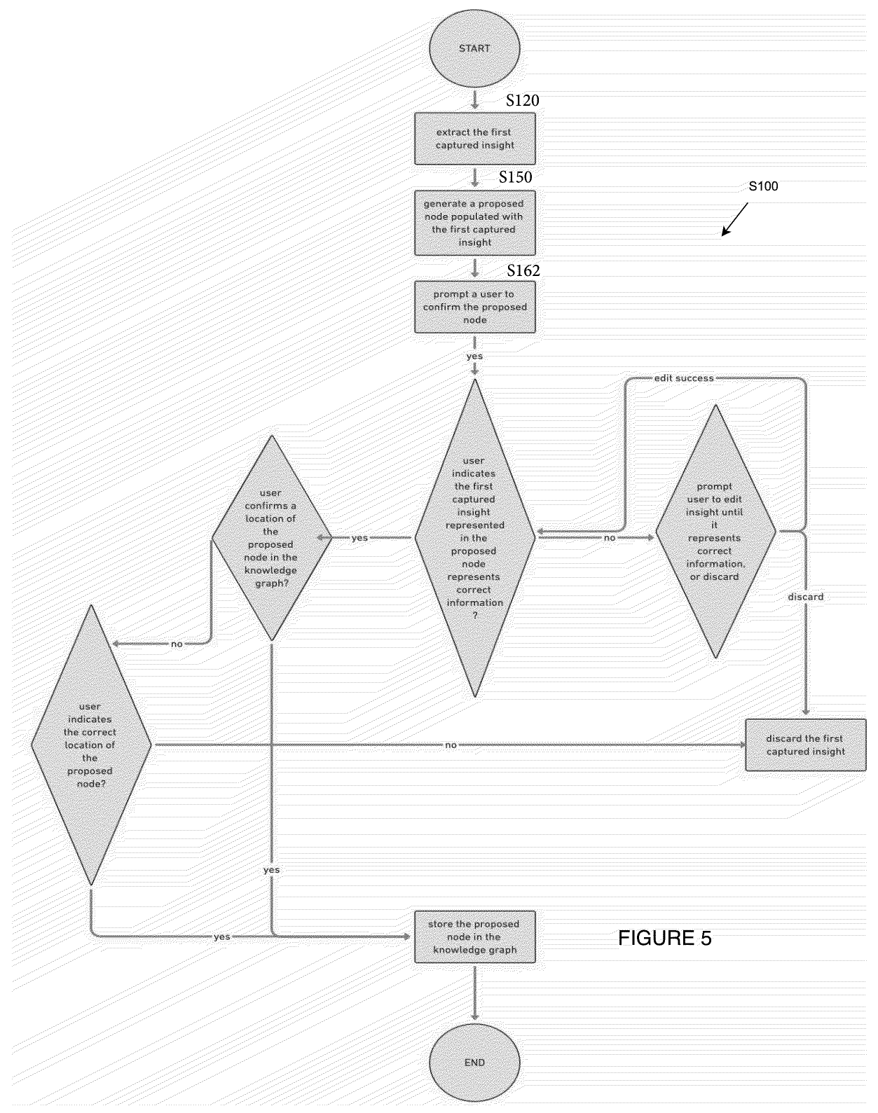

In this example, one captured insight in the set of insights can include, “it's important to consider ways to make visitors feel welcome, like providing snack” and another captured insight in the set of insights can include “providing a tour of the property to the visitors.” For each insight in the set of insights, the computer system can: characterize a relationship (e.g., parent, child, self) between the captured insight (e.g., extracted insight) and a stored insight represented within the initial node; and, based on the captured insight, generate a prompt associated with the captured insight. For example, for the captured insight, “providing a tour of the property to the visitors,” the computer system can generate a prompt, “share tips for leading a successful property tour.” Based on the relation, the computer system can generate a proposed node populated with the captured insight and the prompt, the proposed node assigned a location in the knowledge graph (e.g., child node of the initial node, sibling node of the initial node, parent node of the initial node). The computer system can then: generate a request to add the proposed node to the knowledge graph; present this request to an administrator of the knowledge graph, as shown in FIGS. 4 and 5; and store the proposed node to the knowledge graph as the second node in response to the administrator confirming the proposed node.

Over time, the computer system can: implement machine learning, artificial intelligence, and/or other techniques to refine the large language model, the word vector cube, or other retrieval augmented generation architecture, etc. based on feedback from the administrator; calculate confidence scores for accuracy of data contained new nodes and their connections to other nodes; and selective serve such requests to the administrator for a new node only when the confidence score of the new node is less than a threshold confidence. The computer system can therefore serve fewer new nodes—in populations of new nodes generated by the computer system—to the administrator for confirmation over time.

### 2.2 Glossary and Terms

Generally, “node,” as used herein, represents a container for a set of insights linked to a topic. A node can also include: a discussion prompt configured to initiate a guided conversation about the topic; and a set of educational materials, such as videos and transcripts of guided conversations prompted by the discussion prompt and/or articles and learning modules related to the topic specified in the node.

“Insight,” as used herein, represents a unit of knowledge, such as a concept, an idea, a procedure, or a set of facts, related to a topic.

“Lesson”, as used herein, refers to a set of educational materials, such as educational videos, interactive modules, guided discussion prompts, or summaries, configured to teach or facilitate teaching an insight represented in the knowledge graph.

“Relationship,” as used herein, refers to a relationship between the nodes in the knowledge graph. For example, the “relation” between two nodes in the knowledge graph can be that of a parent node (e.g., higher-level node) and a child node (e.g., lower-level node). The computer system can identify the relationship between two nodes based on the proximity of language between the prompts and/or insights associated with the two nodes.

“Prompt,” as used herein, refers to a question or a statement intended to initiate a conversation about the unit of knowledge represented by the node and/or about a specific insight when presented to the users.

### 3. Knowledge Capture Responsive to a Prompt

Blocks S108, S112, S114 and S116 of the method S100 recite, during a first time period: initiating a first video conference between a first user and a second user; serving a first prompt to the first user and the second user; and recording a first audio file and a first video file of the first video conference. Generally, in Blocks S108, S112, S114 and S116, the computer system can: initiate a virtual (or “remote”) discussion between the pair of users on a topic related to the first prompt; and record the virtual discussion between the pair of users. For example, during the video conference, the computer system can display the first prompt via a display of a first mobile device of the first user, record the first video file of the first user via a camera of the first mobile device, and record the first audio file of the first user speaking via a microphone of the first mobile device, while simultaneously live-streaming the first video file and the first audio file to a second mobile device of the second user. After the completion of the video conference, the computer system can transcribe the first audio file into the first transcript. Therefore, the computer system can: prompt a pair of users to share knowledge relevant to the first prompt; and capture the knowledge shared by the pair of users in audio and/or textual format in order to categorize this knowledge based on its content and represent it as one or more nodes in the knowledge graph.

In one implementation, during the first video conference, the computer system can: livestream a second audio file and a second video file of the first user to the second user; livestream a third audio file and a third video file of the second user to the first user; present the first prompt to the first user and the second user for discussion; compile the second audio file and the third audio file into a first audio file; compile the second video file and the third video file into the first video file; and store the first audio file and the first video file for processing. Therefore, the computer system can: enable the pair of users to discuss the first prompt and exchange information related to the first prompt and to generate new insights evoked by the first prompt. In addition, the computer system can store a recording of the conversation between the pair of users for analysis and insight extraction.

### 4. Captured Insight Extraction

Blocks S116 and S120 of the method S100 recite: generating a first transcript of the first audio file; and, based on the first transcript, extracting a first captured insight representing a first unit of knowledge communicated between the first user and the second user during the first video conference. Similarly, Blocks S118 and S120 recite: accessing a set of language concepts representing a discussion between the first user and the second user responsive to the first prompt; and, based on the set of language concepts, extracting the first captured insight representing the first unit of knowledge communicated between the first user and the second user responsive to the first prompt. Generally, in Blocks S116, S118, and S120 and as shown in FIGS. 1, 2, and 3, the computer system can: transcribe the discussion between the first user and the second user; access the language concepts, such as semantic, ontological, and/or hierarchical representations of words in the discussion; and identify one or more captured insights discussed by the first user and the second user. For example, based on the first transcript, the computer system can generate a textual summary of the first captured insight, the textual summary representing the unit of knowledge associated with the first captured insight; and containing the language concepts associated with the first insight. Therefore, the computer system can automatically extract insights (i.e., captured insights) that represent units of knowledge that may be relevant and/or informative to other users in the organization and that can be represented as nodes in the knowledge graph.

In one implementation, the computer system can access the set of language concepts representing the discussion between the first user and the second user by applying speech recognition software to: transcribe the first audio file into text; normalize the text to remove capitalization and stop words (e.g., filler words, articles, pronouns, etc.); reduce the words in the text to their base form; and assign grammatical and/or semantic tags to the words. Therefore, the computer system can prepare a transcript of the conversation between the pair of users for processing by a machine learning model.

In one implementation, to extract the first captured insight from the first discussion includes, the computer system can: prompt a first large language model (e.g., machine learning model), trained for insight identification, to identify a set of captured insights contained in the transcript; prompt the first large language model to generate a summary of the set of captured insights; and access the first captured insight, in the set of captured insights, and a first textual summary of the first captured insight output by the first large language model. Therefore, the computer system can interface with the first large language model, trained for insight identification, to extract captured insights of the first discussion and based on the first transcript.

For example, the computer system can: identify a set of pauses in speech of the first user and the second user recorded in the first audio file, the set of pauses representing boundaries between topics communicated between the first user and the second user during the first video conference; segment the first transcript into a set of transcript segments at timestamps corresponding to the set of pauses; based on language concepts contained in each transcript segment in the set of transcript segments, extract a meaning of each transcript segment in the set of transcript segments; aggregate meaning of each transcript segment in the set of transcript segments into a first captured insight, in a first set of captured insights; and select the first captured insight from the first set of captured insights. Therefore, the computer system can automatically identify captured insights in the discussion based on pauses in the discussion between the first user and the second user.

In another example, the computer system can: segment the first transcript into a set of transcript segments based on tone, volume, pitch, and inflection of a voice and a rate of speech of the first user and the second user. For example, the computer system can: identify a first transcript segment, in the set of transcript segments, corresponding to a first audio segment characterized by a first speed and a first volume of the speech of the first user; and identify a second transcript segment, in the set of transcript segments, corresponding to a second audio segment characterized by a second speed and a second volume of the speech of the first user. Then, the computer system can: extract a meaning of each transcript segment in the set of transcript segments based on language concepts contained in each transcript segment; transform the meaning of each transcript segment in the set of transcript segments into a captured insight in the first set of captured insights; and select the first captured insight from the first set of captured insights. Therefore, the computer system can automatically identify captured insights in the discussion based on voice characteristics such as tone, volume, pitch, and inflection of the voice and the rate of speech of the first user and the second user.

In one implementation, the computer system can extract the set of insights from the conversation between the first user and the second user by: identifying boundaries between topics in the conversation; based on the boundaries, segmenting the audio transcript into a set of transcript segments; and extracting a meaning of each transcript segment in the set of transcript segments. In particular, to identify the boundaries between the topics in the conversation, the computer system can: identify specific keywords, phrases, or cues in the audio transcript that indicate topic transitions in the conversation; identify significant pauses in the conference audio file (e.g., longer pauses can indicate the end of a discussion or topic); and identify changes in frequency of speech between the first user and the second user (e.g., change in frequency of speech of the first user can indicate transition of discussion from a topic led by the first user to a topic led by the second user) in the audio transcript.

Additionally, or alternatively, the computer system can identify the boundaries between the topics in the conversation and apply text classification techniques to categorize the conversation into classes representing individual topics. For example, the computer system can identify a first unique set of keywords associated with the first topic in the first segment of the transcript and a second unique set of keywords associated with a second topic in a second segment of the transcript. Then, to segment the audio transcript into the set of transcript segments, the computer system can split the audio transcript into the set of transcript segments at the boundaries. The computer system can then extract a meaning of each transcript segment in the set of transcript segments by identifying entities, such as names of people, names of organizations, dates, locations, in the audio The computer system can further perform sentiment analysis of the transcript segment to identify sentiments associated with each topic. For example, the computer system can identify a positive sentiment in the first transcript segment describing a first set of actions indicating that the first set of actions is encouraged. In addition, the computer system can extract a first set of insights from the conversation based on the identified entities, topics, and sentiments. Furthermore, the computer system can, for each transcript segment in the set of transcript segments: apply a large language model to generate a summary of the transcript segment based on the meaning of the transcript segment; and output the summary of the transcript segment as a captured insight. Therefore, the computer system can apply a variety of speech processing techniques, machine learning models, and artificial intelligence models to analyze the conversation and extract a set of captured insights from the conversation between the pair of users.

### 5. Calculating Distances Between Insights

Blocks S130 and S135 of the method S100 recite: calculating a first set of distances between the first captured insight and a set of stored insights represented in a set of nodes contained in a knowledge graph; and identifying a second node, in the set of nodes in the knowledge graph, representing a second stored insight associated with a shortest distance, in the first set of distances, to the first captured insight. Generally, in Blocks S130 and S135 and as shown in FIGS. 1 and 3, the computer system can: calculate distance between the first captured insight and each stored insight represented in the knowledge graph, the distance representing semantic proximity between language concepts of a pair of insights; identify a stored insight associated with a shortest distance to the first captured insight; and identify a node in the graph, which corresponds to this stored insight. Therefore, the computer system can: identify a second node in the knowledge graph representing a stored insight semantically proximal (i.e., having a related meaning or associated with a similar set of language concepts) the first captured insight. By identifying this second node, the computer system can automatically select a correct location of the first captured insight in the knowledge graph, the correct location of the first captured insight proximal the second node in the knowledge graph. For example, the correct location of the first captured insight can include a neighboring node (e.g., child node, parent node, sibling node) of the second node or the correct location of the first captured insight can include the second node.

In one implementation, the computer system can: represent the first captured insight as a first embedding vector in a multidimensional vector space containing embedding vectors representing the set of stored insights represented in the set of nodes contained in the knowledge graph; calculate a first set of cosine similarities and/or Euclidean distances between the first embedding vector and the embedding vectors representing the set of stored insights; and map the first set of cosine similarities and/or Euclidean distances to the first set of distances between the first captured insight and the set of stored insights represented in the set of nodes. More specifically, the computer system can represent the first captured insight as the first embedding vector in the multidimensional vector space by: assigning a numerical value, in a set of numerical values, to each language concept, in a subset of language concepts associated with the first insight; and representing the first set of numerical values as the first embedding vector in the multidimensional vector space.

Similarly, the computer system can represent each stored insight as an embedding vector in the multidimensional vector space. Therefore, the computer system can represent the first captured insight and the set of stored insights represented in the knowledge graph in a single, multidimensional vector space in order to calculate distances between the first captured insight and each stored insight in the set of stored insights. By calculating distances between the first captured insight and each stored insight in the set of stored insights, the computer system can identify a second node in the knowledge graph, representing a second stored insight associated with a shortest distance, and therefore closest meaning, to the first captured insight.

In one implementation, the computer system can: identify an insight in the set of insights; transform a text associated with the insight into numerical representations characterizing the text, such as a word embedding, bag-of-words model, or Term Frequency-Inverse Document Frequency product; calculate a similarity measure-such as cosine similarity, Euclidean similarity, or Levenstein distance-between the numerical representations of the text and a text of each insight in the set of insights; apply a clustering algorithm, such as K-means algorithm, to generate a clustered representation of similarity of insights in the set of all insights (e.g., a clustered representation where pairs of similar insights closer together than pairs of dissimilar insights); based on the clustered representation, identify a stored insight most semantically similar to the first captured insight and a node associated with the stored insight.

In one implementation, the computer system can update the clustered representation of the similarity between insights each time a new insight is identified and selected for addition to the knowledge graph. Therefore, the computer system can conserve computational resources by finding the location of each new insight in the clustered representation instead of re-clustering all insights in the set of insights when identifying the location of a new insight.

### 6. Calculating Specificities of Insights

Blocks S140 and S145 of the method S100 recite: deriving a first specificity score of the first captured insight; and accessing a second specificity score of the second stored insight represented by the second node. Generally, in Blocks S140 and S145 and as shown in FIG. 3, the computer system can derive or retrieve the specificity scores of the first captured insight and the second stored insight, a specificity score representing relative precision with which the insight addresses a particular topic. Therefore, the computer system can: derive or retrieve the specificity scores of the first captured insight and the second stored insight; based on these specificity scores, identify whether the first captured insight or the first stored insight is a more general insight; and identify whether a node representing the first captured insight is ancestral to or descendent from a second node presenting the second stored insight.

In one implementation, the computer system can derive the first specificity score of the first captured insight based on a word count and a quantity of unique terms in a summary of the first captured insight. In this implementation, the computer system can: generate a first textual summary of the first captured insight; identify a first word count of the first textual summary; identify a first quantity of unique terms in the second textual summary; and derive the first specificity score of the first captured insight, the first specificity score correlated with the first word count and with the first quantity of unique terms. Similarly, prior to the first time period, the computer system can: generate a second textual summary of the second stored insight represented by the second node; access a second word count of the second textual summary; access a second quantity of unique terms in the first textual summary; and derive the second specificity score of the second stored insight, the second specificity score correlated with the second word count and the second quantity of unique terms. Therefore, the computer system can: automatically derive a specificity score of an insight based on a word count of its summary or a quantity of unique terms in its summary, both indicative of a specificity of content of the insight.

In another implementation, prior to the first time period, the computer system can: access a second set of relative specificities of a second set of language concepts representing a second discussion between a fourth user and a fifth user responsive to a second prompt and associated with the second stored insight; and aggregate the second set of relative specificities into the second specificity score of the second stored insight. More specifically, the computer system can access a second set of relative specificities including numerical values representing specificities of the second set of language concepts. For example, the computer system can assign: a first relative specificity to a language concept, “mammal;” a second relative specificity exceeding the first relative specificity to a language concept, “horse;” and a third relative specificity exceeding the second relative specificity to a language concept “mare.”

Furthermore, the computer system can aggregate the second set of relative specificities into the second specificity score of the second stored insight by performing arithmetic operations on the numerical values representing specificities of the second set of language concepts. For example, the computer system can aggregate the second set of relative specificities into the second specificity score by averaging the numerical values. Similarly, the computer system can calculate the first specificity score of the first captured insight by: identifying a first set of relative specificities of the first set of language concepts; and aggregating the first set of relative specificities into the first specificity score of the first captured insight. Therefore, the computer system can calculate the specificity scores of the first captured insight and the second stored insight based on the relative specificities of the sets of language concepts represented in the first captured insight and the second stored insight.

### 7. Characterizing Relationships Between Insights

In one implementation shown in FIGS. 1 and 2, the computer system can characterize the relationship between the first captured insight and the second stored insight by identifying that the first captured insight is either: analogous to the second stored insight, indicating that the second stored insight and the first captured insight share the same set of core concepts; a child of the second stored insight, indicating the second stored insight is a prerequisite for understanding the first captured insight; a parent of the second stored insight, indicating that the first captured insight is a prerequisite for understanding the second stored insight; or is a sibling of the second stored insight indicating that the first captured insight is complementary to the second stored insight and that a third insight associated with a parent node of the first node (if such a node exists in the knowledge graph) is a prerequisite to understanding the first captured insight. Therefore, the computer system can identify whether the first captured insight has a prerequisite or whether the first captured insight is a prerequisite for another known insight, such as the second stored insight. Based on this information, the computer system can find a correct placement of the second node associated with the first captured insight within the knowledge graph. By identifying the correct placement of the second node within the knowledge graph, the computer system can prompt a pair of users to discuss the first captured insight only if both users in the pair of users have prerequisite knowledge to understand the first captured insight.

In one implementation, to characterize the relationship of the first captured insight to the second stored insight, the computer system can: calculate a proximity metric representing semantic proximity between the second text (e.g., summary of the first captured insight, transcript segment associated with the first captured insight) associated with first captured insight and a first text (e.g., summary of the second stored insight, transcript segment associated with the second stored insight) associated with the second stored insight. In particular, the computer system can quantitatively characterize variability of words, local dependencies of words, and long-range dependencies of words in the first text and in the second text and quantify the proximity between the second text and the first text. In one example, in response to a proximity metric between first captured insight and second stored insight exceeding a threshold proximity, the computer system can identify that the second stored insight and first captured insight are the same. Therefore, the computer system can determine the location of a proposed new node in the knowledge graph based on the proximity of language between the captured insight associated with the proposed new node and the stored insights represented in the existing nodes in the knowledge graph.

In another implementation, to characterize the relationship of the first captured insight to the second stored insight, the computer system can identify a set of keywords associated with the first captured insight and utilize frequency of a keyword in the set of keywords to determine relation. In one example, the computer system can: identify a first frequency of a keyword in the first text associated with the second stored insight, the keyword first appearing in the first text; identify a second frequency of the keyword in the second text associated with the second node; and, in response to the second frequency exceeding the first frequency, classify the first captured insight as a child of the second stored insight. In another example, the computer system can: identify a first unique set of keywords in the first text and a second unique set of keywords in the second text, the first unique set of keywords and the second unique set of keywords containing different keywords; and, in response to a third text associated with the third stored insight represented the parent node of a second node containing the first unique set of keywords and the second unique set of keywords, classify the first captured insight as a sibling of the second stored insight. Therefore, the computer system can determine the location of a proposed new node populated with the first captured insight in the knowledge graph based on frequencies of keywords in the text associated with the first captured insight and frequencies of the keywords in the texts associated of the set of insights represented in the knowledge graph.

### 8. Proposing a New Child Node

Blocks S150, S152, and S154 of the method S100 recite, in response to the first specificity score exceeding the second specificity score: generating a proposed child node; populating the proposed child node with the first captured insight; and defining the proposed child node as descendent from the second node in the knowledge graph. Generally, in Blocks S150, S152, and S154 and as shown in FIGS. 4 and 5, the computer system can: identify that the first captured insight is more specific than the second stored insight in response to the first specificity score exceeding the second specificity score; and generate a proposed child node descendent from the second node and populated with the first captured insight. Therefore, the computer system can: automatically generate a proposed child node populated with the first captured insight; and define a location of the proposed child node in the knowledge graph proximal the nodes representing semantically similar insights to the first captured insight. Thus, the computer system can tentatively add the proposed child node to the knowledge graph prior to confirming the proposed child node with a third user.

In one implementation, the computer system can generate the proposed child node in response to the first specificity score exceeding the second specificity score and in response to the shortest distance falling within a distance range between a first distance threshold (e.g., low threshold) and a second distance threshold (e.g., high threshold). In this implementation, in response to the shortest distance falling within the distance range between the first distance threshold and the high threshold, the computer system can detect that the first captured insight and the second stored insight are semantically similar, yet not analogous. Thus, the computer system can store the first captured insight and the second stored insight in neighboring, yet separate nodes.

### 9. New Node Validation

Blocks S160, S162, S180 of the method S100 recite: in response to the first specificity score exceeding the second specificity score, serving a first visual representation of the proposed child node in the knowledge graph to a third user and prompting the third user to confirm the proposed child node; and, in response to receiving a first confirmation of the proposed child node from the third user, storing the proposed child node as a first node, descendent from the second node in the knowledge graph. Generally, in Blocks S160, S162, and S180 and as shown in FIGS. 4 and 5, the computer system can: prompt the third user, such as an administrator of the knowledge graph, to confirm a accuracy (e.g., accuracy of the information associated with the first child insight) of the first captured insight and a placement of the proposed child node, populated with the first captured insight, in the knowledge graph; and, in response to receiving the confirmation, store the proposed child node in the knowledge graph, under the second node, as the first node. Therefore, the computer system can: automatically extract the first captured insight of the discussion between the pair of users; automatically identify a location of the proposed child node populated with the first captured insight in the knowledge graph; prompt the third user to confirm the first captured insight and a location of the proposed node in the knowledge graph; and, in response to receiving the confirmation, store the proposed node in the knowledge graph. Thus, the computer system can validate the proposed nodes prior to storing or inserting the proposed nodes in the knowledge graph, as shown in FIG. 7, thereby increasing fidelity of information represented in the knowledge graph.

In one implementation, the computer system can: prompt an administrator of the knowledge graph to confirm adding the proposed node to the knowledge graph; in response to the administrator electing to add the proposed node to the knowledge graph, prompt the administrator to confirm the location of the proposed node in the knowledge graph; in response to the administrator confirming the location of the proposed node in the knowledge graph, prompt the administrator to confirm a prompt associated with the proposed node; and, in response to the administrator confirming the prompt, store the proposed node to the knowledge graph as a new node. Thus, the computer system can verify that a new node, corresponding to the proposed node, is placed in the correct location in the knowledge graph and that the prompt of the new node reflects the captured insight associated with the node and can be used to initiate a conversation about the captured insight.

In another implementation, the computer system can: prompt the administrator of the knowledge graph to confirm the location of the proposed node in the knowledge graph; in response to the administrator indicating that the location of the proposed node is incorrect, prompt the administrator to select the location of the proposed node; in response to receiving the updated location of the proposed node selected by the administrator, prompt the administrator to confirm the prompt associated with the second node; in response to the administrator indicating that the prompt of the second node is incorrect, prompt the administrator to edit the prompt; and, in response to receiving the updated prompt edited by the administrator, store the proposed node as a new node to the knowledge graph, the new node assigned the updated location and populated with the updated prompt. Therefore, the computer system can prompt the administrator to correct the proposed location of the proposed node and to edit the prompt associated with the proposed node to ensure that the node is added at a correct location and that the prompt best reflects the insight associated with the node.

In another implementation, in response to extracting a first captured insight based on a conversation between a pair of users assigned an initial node, the computer system can: generate a prompt for the first captured insight based on the first captured insight; generate a proposed node that is a child node of the initial node assigned to the first user and the second user; present an administrator of the knowledge graph with a request to add the proposed node to the knowledge graph as a child node of the initial node; and, in response to the administrator electing to add the proposed node to the knowledge graph, present the administrator with a request to confirm the location of the proposed node in the knowledge graph. Alternatively, in response to the administrator indicating that the proposed node is not a child node of the initial node, the computer system can: present the administrator with a request to select the location of the of the proposed node; and, in response to accessing an updated location of the proposed node provided by the administrator, store the proposed node as a new node to the knowledge graph, the new node assigned the updated location.

Therefore, the computer system can: automatically set the initial node that generated an first captured insight as a parent node of the proposed node; if the administrator disconfirms the initial node as a parament of the proposed node, request the administrator of the knowledge graph to select the correct location for the node in the knowledge graph; and forgo characterizing the relationship between the initial node and the proposed node in order to conserve computational resources.

### 10. Lesson Generation

Blocks S170 and S180 of the method S100 recite, in response to receiving a first confirmation of the proposed child node from the third user: generating a lesson based on the first captured insight, the first transcript, and the first video file; and storing the proposed child node as a first node, descendent from the second node and populated with the lesson, in the knowledge graph. Generally, in Blocks S170 and S180, the computer system can: transform the recording (e.g., first audio file, first video file) of the discussion between the pair of users into a lesson or a set of educational materials configured to teach or facilitate teaching of the first captured insight. For example, the computer system can transform the first captured insight, the first transcript, and the first video file into an educational video about the first captured insight, an interactive training module configured to teach the first captured insight, a short text (e.g., article) summarizing the first captured insight, and/or a series of guided prompts configured to prompt one or more users to discuss the first captured insight. Therefore, the computer system can transform the recorded first conversation between the pair of users into educational materials configured to teach or facilitate teaching of the insights extracted from the recorded first conversation. Furthermore, the computer system can store these educational materials in the first node associated with the first captured insight for later retrieval and deployment to users.

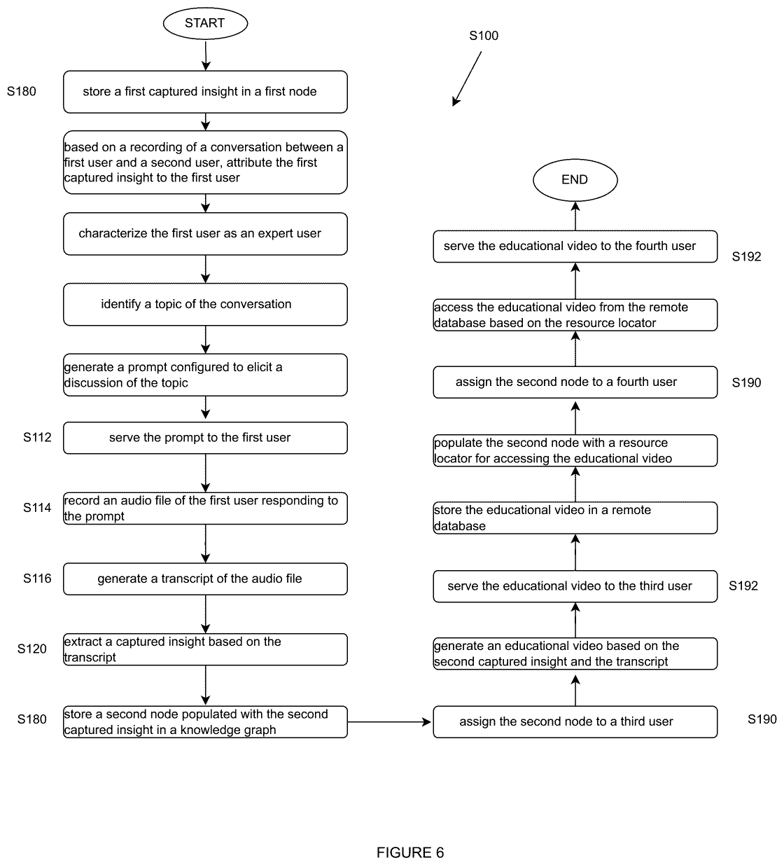

In one example shown in FIG. 6, the computer system can: identify a set of subtopics associated with the first captured insight based on language concepts represented in the first transcript; extract a series of video segments, from the first video file, each video segment in the series of video segments containing portion of the first video conference in which the first user and the second user discuss each subtopic, in the set of subtopics; compile the series of video segments into an educational video; and generate the lesson including the educational video. Therefore, the computer system can generate an educational video configured to teach the first captured insight, the educational video composed of a series of video segments of the first video file of the discussion between the pair of users. For example, the computer system can serve the educational video to a single user to teach the first captured insight to the single user.

In another example, the computer system can: convert the first transcript into a series of guided prompts configured to prompt a pair of users to discuss the first captured insight; and generate the lesson including the series of guided prompts. Therefore, the computer system can automatically generate the lesson configured to prompt discussion of the first captured insight by one or more users to: facilitate peer-to-peer teaching of the first captured insight; or captured additional insights related to the first captured insight.

In one implementation, the computer system can generate a first type of lesson (e.g., interactive training module) in response to assigning the first node to a single user and generate a second type of lesson (e.g., series of guided prompts) in response to assigning the first node to more than one user. In one example, the computer system can assign the first node to a fourth user and, in response to assigning the first node to the fourth user: convert the set of language concepts into a training module on a topic associated with the first captured insight; populate the first node with the training module; and serve the training module to the fourth user. Therefore, in response to assigning the first node to a single user, the computer system can generate a lesson configured to teach the captured insight to the single user (rather than a group of users). In another example, the computer system can assign the first node to a fifth user and a sixth user and, in response to assigning the first node to the fifth user and the sixth user: convert the first transcript into a series of guided prompts configured to prompt a pair of users to discuss the first captured insight; populate the first node with the series of guided prompts; and sequentially serve the series of guided prompts to the fifth user and the sixth user. Therefore, in response to assigning the first node to more than one user, the computer system can generate a lesson configured to facilitate peer-to-peer teaching of the first captured insight or a discussion on the topic related to the captured insight.

### 11. Serving the Lesson to a New User

Blocks S190 and S192 of the method S100 recite, during a second time period succeeding the first time period: assigning the first node to a fourth user; and serving the lesson—from the first node—to the fourth user. Generally, in Blocks S190 and S192, the computer system can assign the first node to a new user, such as the fourth user, in order to teach the first insight to the fourth user. For example, the computer system can configure a mobile application installed on a third device of the fourth user to display the educational materials, such as an educational video or an interactive module, stored in the first node to the fourth user. Therefore, after generating the lesson, the computer system can automatically present the lesson to users by assigning the first node these users.

In one implementation, the computer system can: store the lesson, such as the educational video, in a remote database; and populate the first node with a resource locator for accessing the lesson. Then, the computer system can: access the lesson, such as the educational video, from the remote database based on the resource locator; and serve the lesson to the fourth user. Therefore, the computer system can store educational materials configured to teach or facilitate teaching of the first captured insight in a remote location, such as a cloud server, thereby eliminating a need to store the educational materials in a local memory of a mobile device of the fourth user. Furthermore, the computer system can store the educational materials of each node in the knowledge graph in a single remote location and selectively serve these educational materials to users.

### 12. User Tracking

In one implementation, the computer system can assign a node in the knowledge graph to a user in the user population. For example, at a first time, the computer system can assign the first node to the first user. At a second time succeeding the first time, the computer system can assign the second node—which is a child of the first node—to the first user. At a third time succeeding the second time, the computer system can assign the fourth node—which is a child of the second node—the first user. Therefore, the computer system can successively assign nodes—descendant from previously—assigned nodes—to the first user, thus exposing the first user to increasingly specific or specialized insights.

In another implementation, the computer system can assign a first node to a first user and a second user at a first time. At a second time, the computer system can: select a third user and a fourth user, different from the first user and the second user, from the user population; and assign the first node to the third user and the fourth user. For example, in this implementation, the computer system can implement rules for grouping users assigned to individual nodes in the knowledge graph, such as: excluding grouping two users from two different teams, divisions, departments, cohorts, or units within the organization for one discussion related to one node in the knowledge graph.

However, the computer system can implement any other method or technique to assign individual nodes in the knowledge graph to one or a set of users the organization, thereby exposing users to different nodes-containing different stored insights-over time.

### 13. Node Tagging

In this implementation, the computer system can tag a node with a tag designating a target user population to be assigned to the node. For example, the computer system can: identify a first target user population (e.g., managers in an organization) for a proposed first node associated with the first stored insight; and identify a second target user population (e.g., interns) for a proposed second node associated with the second stored insight. Then, the computer system can only assign users from the first user population to the first node and users from the second user population to the second node. Therefore, the computer system can tag nodes in the knowledge graph with tags indicating a target user population for each node. This allows the computer system to avoid assigning a user to a node associated with a stored insight that is not relevant to that user.

### 14. Proposing a New Parent Node

In one implementation, the computer system can: extract a second captured insight representing a second unit of knowledge communicated between the first user and the second user during the first video conference based on the first transcript; calculate a second set of distances between the second captured insight and the set of stored insights represented in the set of nodes contained in the knowledge graph; identify the second node, in the set of nodes in the knowledge graph, associated with a second shortest distance, in the second set of distances, to the second captured insight; and characterize a third specificity score of the second captured insight. Therefore, the computer system can automatically extract a second captured insight, different from the first captured insight, from the first transcript, the second captured insight representing a second unit of knowledge communicated by the first user and the second user during the video conference. Furthermore, the computer system can identify a node in the knowledge graph representing a stored insight defining a second meaning and associated with a second set of language concepts most similar or relevant to a first meaning and a first set of language concepts of the second captured insight. For example, the computer system can identify the second node in the knowledge graph as this node. By identifying this node, the computer system can automatically select a correct placement (e.g., location) of the second captured insight in the knowledge graph to ensure that neighboring nodes in the knowledge graph are semantically related.

In this implementation, the computer system can further: access the second specificity score of the second stored insight; and derive a third specificity score of the second captured insight. Therefore, the computer system can: derive or retrieve the specificity scores of the second captured insight and the second stored insight; and, based on these specificity scores, identify whether a proposed node representing the second captured insight is ancestral to or descendent from the second node representing the second stored insight. Thus, the computer system can automatically select a correct placement (e.g., location) of the second captured insight in the knowledge graph to ensure that ancestral nodes in the knowledge graph contain pre-requisite concepts for learning concepts represented by the descendant nodes in the knowledge graph.

In this implementation, in response to the second specificity score of the second stored insight exceeding the third specificity score, the computer system can: generate a proposed parent node; populate the proposed parent node with the second captured insight; define the proposed parent node as ancestral to the second node in the knowledge graph; serve a second visual representation of the proposed parent node in the knowledge graph to the third user; and prompt the third user to confirm the proposed parent node. For example, the computer system can: display a textual summary of the second captured insight via a mobile device of the third user; and prompt the user to confirm that the second captured insight contains correct information. Then, the computer system can: display, via a mobile device of the third user, a visual representation of a portion of the knowledge graph including the proposed parent node and a group of neighboring nodes, each node labeled with the corresponding insights; and prompt the user to confirm the placement of the proposed parent node in the knowledge graph.

Therefore, the computer system can identify a relationship of the second node and a proposed node based on the specificity scores of the second captured insight and the second stored insight, the relationship indicating an order in which the proposed node and the second node will be served to a user. Generally, as the second captured insight is less specific than the second stored insight, the computer system can assign a confirmed proposed node to a user prior to assigning the second node to the user. Furthermore, the computer system can prompt the third user, such as the administrator of the knowledge graph, to confirm the accuracy (e.g., correctness) of the second captured insight and the placement of the second captured insight in the knowledge graph.

In one implementation, the computer system can generate the proposed parent node in response to the second specificity score exceeding the third specificity score and in response to the second shortest distance falling within the distance range between a first distance threshold and a second distance threshold. In this implementation, in response to the shortest distance falling within the distance range between the first distance threshold and the second distance threshold, the computer system can detect that the second captured insight and the second stored insight are semantically similar, yet not analogous. Thus, the computer system can store the second captured insight and the second stored insight in neighboring, yet separate nodes.

### 14.1 Confirmation of the Proposed Parent Node

In one implementation, in response to receiving a second confirmation of the proposed parent node from the third user, the computer system can store the proposed parent node as a third node, ancestral to the second node, in the knowledge graph. Therefore, the computer system can validate the proposed parent node prior to storing it, as the third node, in the knowledge graph, thereby increasing fidelity of information represented in the knowledge graph and improving organization of the knowledge graph.

### 14.2 Disconfirmation of the Proposed Parent Node

In one implementation, in response to receiving a disconfirmation for the proposed parent node from the third user, the computer system can identify a third node, in the set of nodes in the knowledge graph, representing a third stored insight associated with a next shortest distance, in the second set of distances, to the second captured insight, the next shortest distance exceeding the second shortest distance and falling below each other distance in the second set of distances. Therefore, in response to receiving a disconfirmation for the proposed parent node from the third user, which may indicate an incorrect placement of the proposed parent node in the knowledge graph, the computer system can identify a third node in the knowledge graph representing the third stored insight most semantically similar to the second captured insight in the absence of second stored insight. Thus, the computer system can identify an alternative placement of the proposed parent node proximal the third node in the knowledge graph.

The computer system can then: access a fourth specificity score of the third stored insight; and, in response to the fourth specificity score of the third stored insight exceeding the third specificity score of the second captured insight, prompt the third user to confirm the proposed parent node as ancestral to the third node in the knowledge graph. Therefore, the computer system can prompt the third user to confirm the alternative placement of the proposed parent node proximal the third node in the knowledge graph.

In response to receiving a second confirmation of the proposed parent node from the third user, the computer system can store the proposed parent node as a fourth node, ancestral to the third node, in the knowledge graph. Alternatively, in response to receiving a second disconfirmation for the proposed parent node from the third user, the computer system can discard the proposed parent node. Therefore, the computer system can forgo storing the proposed parent node in the knowledge graph in response to receiving a disconfirmation for the proposed parent node from the third user. Discarding disconfirmed proposed nodes enables the computer system to: avoid adding, to the knowledge graph, nodes that may not be useful to the users in the organization; and avoid placing nodes in locations where the nodes lack shared context with the surrounding nodes.

In one implementation, in response to receiving a second disconfirmation for the proposed parent node from the third user, the computer system can prompt the third user to select a node, in the set of nodes, representing a stored insight most similar to the second captured insight. In response to receiving a selection of a third node, representing a third stored insight, from the third user, the computer system can prompt the third user to indicate a relationship of the proposed parent node to the third node. Then, in response to receiving a selection, from the third user, indicating that the proposed parent node is ancestral to the third node, the computer system can store the proposed parent node as a fourth node ancestral to the third node in the knowledge graph. Therefore, in response to receiving a second disconfirmation for the proposed parent node from the third user, the computer system can: prompt the third user to select the correct placement of the proposed parent node in the knowledge graph; and store the proposed parent node as a fourth node at the location in the knowledge graph selected by the third user.

### 15. Adding Content to Existing Node

In one implementation, the computer system can: extract the second captured insight representing the second unit of knowledge communicated between the first user and the second user during the first video conference; calculate the second set of distances between the second captured insight and the set of stored insights represented in the set of nodes contained in the knowledge graph; identify a third node, in the set of nodes in the knowledge graph, representing a third stored insight associated with a second shortest distance, in the first set of distances, to the second captured insight; and, in response to the second shortest distance falling below the first distance threshold, populate the third node with the second captured insight.

In this implementation, in response to the second shortest distance falling below the first distance threshold, the computer system can detect that the second captured insight and the third stored insight are analogous insights, exhibiting a high level of semantic similarity. Thus, the computer system can populate the third node with the second captured insight such that the third node contains both the third stored insight and the second captured insight and includes a second lesson configured to teach or facilitate teaching both the third stored insight and the second captured insight. By storing two insights exhibiting a high level of semantic similarity in a single node, the computer system can avoid creating redundant nodes in the knowledge graph.

In one implementation, the computer system can: access a node quantity of the set of nodes contained in the knowledge graph; and set the first distance threshold correlated (e.g., proportional) with the node quantity. By adjusting the first distance threshold, the computer system can adjust a rate of generation of proposed new nodes, correlated with a rate of addition of new nodes to the knowledge graph. By setting the first distance threshold correlated with the node quantity, the computer system can reduce the rate of generation of proposed new nodes to avoid creating redundant nodes in the knowledge graph.

In one implementation, the computer system can: prompt the third user to select or adjust the first distance threshold; and set the first distance threshold to the value selected by the third user. By increasing the first distance threshold, the third user can adjust a rate at which the third user is prompted to confirm the proposed nodes. Therefore, the computer system can enable the third user to: adjust the rate at which the third user is prompted to confirm the proposed nodes; and adjust the rate of addition of new nodes to the knowledge graph.

### 16. Discarding a Node

In one implementation, the computer system can: extract a second captured insight representing a second unit of knowledge communicated between the first user and the second user during the first video conference; calculate a second set of distances between the second captured insight and the set of stored insights represented in the set of nodes contained in the knowledge graph; identify a third node, in the set of nodes in the knowledge graph, representing a third stored insight associated with a second shortest distance, in the first set of distances, to the second captured insight; and, in response to the second shortest distance exceeding the second distance threshold, flag the second captured insight as distant from the set of stored insights represented in the set of nodes and discard the second captured insight.

In this implementation, in response to the second shortest distance exceeding the second distance threshold, the computer system can detect that the second captured insight and the third stored insight are distant insights, exhibiting a low level of semantic similarity. Accordingly, in response to the second shortest distance exceeding the second distance threshold, the computer system can discard the second captured insight. Additionally or alternatively, the computer system can: prompt the third user to confirm discarding the second captured insight; and, in response to receiving the confirmation, discard the second captured insight. Therefore, the computer system can discard insights exhibiting a low level of semantic similarity to the set of stored insights contained in the knowledge graph to avoid adding irrelevant insights to the knowledge graph.

In one implementation, the computer system can: access the node quantity of the set of nodes contained in the knowledge graph; and set the second distance threshold inversely correlated (e.g., inversely proportional) to the node quantity. By adjusting the second distance threshold, the computer system can adjust the rate at which captured insights are discarded, which is inversely correlated with a rate of addition of new nodes to the knowledge graph. By setting the second distance threshold inversely correlated with the node quantity, the computer system can reduce the rate of generation of proposed new nodes to avoid representing irrelevant insights in the knowledge graph.

In one implementation, the computer system can: prompt the third user to select or adjust the second distance threshold; and set the second distance threshold to the value selected by the third user. By decreasing the second distance threshold, the third user can reduce a rate at which the third user is prompted to confirm the proposed nodes. Therefore, the computer system can enable the third user to: adjust the rate at which the third user is prompted to confirm the proposed nodes; and adjust the rate of addition of new content to the knowledge graph.

### 17. Example: Capturing New Insights Descendent from the First Insight

In one implementation, during a third time period succeeding the first time period, the computer system can: assign the first node to a fifth user and a sixth user; initiate a second video conference between the fifth user and the sixth user; sequentially serve the series of guided prompts, configured to prompt a pair of users to discuss the first captured insight, to the fifth user and the sixth user; and record a second audio file of the second video conference. Therefore, the computer system can: prompt the pair of users to discuss the first captured insight with the series of guided prompts; and record this discussion between the pair of users.

The computer system can then: generate a second transcript of the second audio file; based on the second transcript, extract a second captured insight representing a second unit of knowledge communicated between the fifth user and the sixth user during the second video conference; calculate a second set of distances between the second captured insight and the set of stored insights represented in the set of nodes contained in the knowledge graph; and identify the first node representing the first captured insight associated with a second shortest distance, in the second set of distances, to the second captured insight. Therefore, the computer system can automatically extract a second captured insight, different from the first captured insight, from the first transcript, the second captured insight representing a second unit of knowledge communicated by the fifth user and the sixth user during the video conference. Furthermore, the computer system can calculate the second set of distances and identify the second shortest distance to verify that the first captured insight, represented by the first node, is most semantically similar to the second captured insight. Thus, the computer system can automatically select placement (e.g., location) of the second captured insight proximal the first captured insight in the knowledge graph as the correct placement.

The computer system can then: derive a third specificity score of the second captured insight; access a first specificity score of the first captured insight represented by the first node; and, in response to the third specificity score exceeding the first specificity score, generate a second proposed child node and populate the second proposed child node with the second captured insight. Therefore, the computer system can capture additional insights, such as the second captured insights, to add to the knowledge graph by: automatically generating discussion prompts configured to prompt discussion of additional topics related to the first captured insight; recording a conversation between a pair of users responding to these discussion prompts; extracting captured insights from the recording of this conversation; and generating proposed new nodes representing these insights. Therefore, the computer system can automatically capture new knowledge provided by users and add this new knowledge to the knowledge graph.

### 18. Example: Capturing New Insights from an Expert User

In one implementation, the computer system can characterize the first user as an expert user based on the first transcript of the first audio file. More specifically, the computer system can characterize the first user as an expert user in response to the first user providing units of knowledge corresponding to one or more captured insights during the first discussion. Then, the computer system can: identify a first topic of the first node based on the first captured insight; generate a second prompt associated with the first topic; and, during a third time period succeeding the first time period, serve the second prompt to the first user and record a second audio file and a second video file of the first user responding to the second prompt. Therefore, the computer system can: characterize the first user as the expert user (e.g., subject matter expert) in response to the first user providing specific and relevant information to the first captured insight during the discussion; and, in response to identifying the first user as the expert user, automatically prompt the first user to provide additional information related to the first captured insight in order to capture additional insights related to the first captured insight.

In this implementation, the computer system can also: generate a second transcript of the first audio file; based on the second transcript, extract a second captured insight representing a second unit of knowledge communicated by the first user on the first topic; based on the second transcript, the second video file, and the second captured insight, generate a second lesson associated with the first topic; and store a third node in the knowledge graph, the third node descendent from the first node and populated with the second lesson and the second captured insight. Therefore, the computer system can: extract the second captured insight by prompting the first user to discuss the first topic associated with the first captured insight; generate a second lesson configured to teach or facilitate teaching the second captured insight; and store the second captured insight and the second lesson in a second node in the knowledge graph. Thus, the computer system can automatically discover additional insights to add to the knowledge graph.

### 19. Example: Prompting Additional Discussion for an Intermediate Node

Blocks S110, S112, S118, S120, and S180 of the method S100 recite, in response to the shortest distance, in the first set of distances between the first captured insight and a set of stored insights represented in a set of nodes contained in the knowledge graph, exceeding a threshold distance: generating a second prompt configured to elicit sharing of knowledge linking the second stored insight to the first captured insight based on the first captured insight and the second stored insight; serving the second prompt to a fourth user; accessing a second set of language concepts representing a response of the fourth user to the second prompt; based on the second set of language concepts, extracting a second captured insight; and inserting an intermediate node, containing the second captured insight, into the knowledge graph between the first node and the second node. Generally, in Blocks S110, S112, S118, S120, and S180, the computer system can detect that the shortest distance between the first captured insight, represented in the first node, and the second stored insight, represented in the second node, exceeds the distance threshold, thereby indicating that information connecting the first captured insight and the second stored insight may be captured and represented in the knowledge graph. In response, the computer system can: prompt the fourth user (or a group of users) to share knowledge linking the second stored insight to the first captured insight; record the fourth user responding to the prompt; based on the recording, extract a second captured insight linking the first captured insight and the second stored insight; and insert an intermediate node, containing the second captured insight into the knowledge graph. Therefore, the computer system can reduce information gaps between insights represented in the knowledge graph.

In one implementation, in response to a difference between the first specificity score of the first captured insight and the second specificity score of the second stored insight exceeding a threshold and in response to the first node and the second node including adjacent nodes in the knowledge graph, the computer system can generate a second prompt configured to elicit sharing of knowledge linking the second stored insight to the first captured insight based on the first captured insight and the second stored insight. Then, the computer system can: serve the second prompt to a fifth user and record a second audio file of the fifth user responding to the second prompt during a third time period succeeding the first time period; generate a second transcript of the second audio file; based on the second transcript, extract a second captured insight; based on the second transcript and the second captured insight, generate a second lesson associated with the second captured insight; and insert an intermediate node, containing the second captured insight and the second lesson, into the knowledge graph between the first node and the second node.

Therefore, the computer system can: identify that intermediate concepts may be missing in the knowledge graph; prompt an additional discussion of the intermediate concepts not yet represented in the knowledge graph; capture these intermediate concepts; and store these intermediate concepts in the knowledge graph. Thus, the computer system can: reduce information gaps in the knowledge graph; ensure that the knowledge graph contains pre-requisite information for teaching each stored insight represented in the knowledge graph; and ensure that different branches of the knowledge graph are characterized by a similar information sparsity.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method includes:
during a first time period:
initiating a first video conference between a first user and a second user;
serving a first prompt to the first user and the second user; and
recording a first audio file and a first video file of the first video conference;
generating a first transcript of the first audio file;
based on the first transcript, extracting a first captured insight representing a first unit of knowledge communicated between the first user and the second user during the first video conference;
calculating a first set of distances between the first captured insight and a set of stored insights represented in a set of nodes contained in a knowledge graph;
identifying a second node, in the set of nodes in the knowledge graph, representing a second stored insight associated with a shortest distance, in the first set of distances, to the first captured insight;
characterizing a first specificity score of the first captured insight;
accessing a second specificity score of the second stored insight represented by the second node;
in response to the first specificity score exceeding the second specificity score:
generating a proposed child node;
populating the proposed child node with the first captured insight;
defining the proposed child node as descendent from the second node in the knowledge graph;
serving a first visual representation of the proposed child node in the knowledge graph to a third user; and
prompting the third user to confirm the proposed child node;
in response to receiving a first confirmation of the proposed child node from the third user:
generating a lesson based on the first captured insight, the first transcript, and the first video file; and
storing the proposed child node as a first node, descendent from the second node and populated with the lesson, in the knowledge graph; and
during a second time period succeeding the first time period:
assigning the first node to a fourth user; and
serving the lesson, from the first node, to the fourth user.

2. The method of claim 1, wherein calculating the first set of distances between the first captured insight and the set of stored insights represented in the set of nodes comprises:
representing the first captured insight as a first embedding vector in a multidimensional vector space containing embedding vectors representing the set of stored insights represented in the set of nodes contained in the knowledge graph;
calculating a first set of cosine similarities between the first embedding vector and the embedding vectors representing the set of stored insights represented in the set of nodes; and
mapping the first set of cosine similarities to the first set of distances between the first captured insight and the set of stored insights represented in the set of nodes.

3. The method of claim 1:
further comprising, prior to the first time period:
generating a first textual summary of the second stored insight represented by the second node;
accessing a first word count of the first textual summary;
accessing a first quantity of unique terms in the first textual summary; and
characterizing the second specificity score of the second stored insight, the second specificity score correlated with the first word count and the first quantity of unique terms; and
wherein characterizing the first specificity score of the first captured insight comprises:
generating a second textual summary of the first captured insight;
identifying a second word count of the second textual summary;
identifying a second quantity of unique terms in the second textual summary; and
characterizing the first specificity score of the first captured insight, the first specificity score correlated with the second word count and with the second quantity of unique terms.

4. The method of claim 1, wherein extracting the first captured insight comprises:
identifying a set of pauses in speech of the first user and the second user recorded in the first audio file, the set of pauses representing boundaries between topics communicated between the first user and the second user during the first video conference;
segmenting the first transcript into a set of transcript segments at timestamps corresponding to the set of pauses;
based on language concepts contained in each transcript segment in the set of transcript segments, extracting a meaning of each transcript segment in the set of transcript segments;
aggregating meaning of each transcript segment in the set of transcript segments into an insight, in a first set of captured insights; and
selecting the first captured insight from the first set of captured insights.

5. The method of claim 1, further comprising:
based on the first transcript, extracting a second captured insight representing a second unit of knowledge communicated between the first user and the second user during the first video conference;
calculating a second set of distances between the second captured insight and the set of stored insights represented in the set of nodes contained in the knowledge graph;
identifying the second node, in the set of nodes in the knowledge graph, associated with a second shortest distance, in the second set of distances, to the second captured insight;
characterizing a third specificity score of the second captured insight; and
in response to the second specificity score of the second stored insight exceeding the third specificity score:
generating a proposed parent node;
populating the proposed parent node with the second captured insight;
defining the proposed parent node as ancestral to the second node in the knowledge graph;
serving a second visual representation of the proposed parent node in the knowledge graph to the third user; and
prompting the third user to confirm the proposed parent node.

6. The method of claim 5, further comprising:
in response to receiving a second confirmation of the proposed parent node from the third user, storing the proposed parent node as a third node, ancestral to the second node, in the knowledge graph.

7. The method of claim 5, further comprising:
in response to receiving a disconfirmation for the proposed parent node from the third user:
identifying a third node, in the set of nodes in the knowledge graph, representing a third stored insight associated with a next shortest distance, in the second set of distances, to the second captured insight, the next shortest distance exceeding the second shortest distance and falling below each other distance in the second set of distances;
accessing a fourth specificity score of the third stored insight; and
in response to the fourth specificity score of the third stored insight exceeding the third specificity score of the second captured insight, prompting the third user to confirm the proposed parent node as ancestral to the third node in the knowledge graph; and
in response to receiving a second disconfirmation for the proposed parent node from the third user, discarding the proposed parent node.

8. The method of claim 5, further comprising:
in response to receiving a second disconfirmation for the proposed parent node from the third user, prompting the third user to select a node, in the set of nodes, representing a stored insight most similar to the second captured insight;
in response to receiving a selection of a third node, representing a third stored insight, from the third user, prompting the third user to indicate a relationship of the proposed parent node to the third node; and
in response to receiving a selection, from the third user, indicating that the proposed parent node is ancestral to the third node, storing the proposed parent node as a fourth node ancestral to the third node in the knowledge graph.

9. The method of claim 1:
wherein generating the proposed child node comprises:
in response to the first specificity score exceeding the second specificity score and in response to the shortest distance falling within distance a distance range between a first distance threshold and a second distance threshold, generating the proposed child node; and
further comprising:
based on the first transcript, extracting a second captured insight representing a second unit of knowledge communicated between the first user and the second user during the first video conference;
calculating a second set of distances between the second captured insight and the set of stored insights represented in the set of nodes contained in the knowledge graph;
identifying a third node, in the set of nodes in the knowledge graph, representing a third stored insight associated with a second shortest distance, in the first set of distances, to the second captured insight; and
in response to the second shortest distance exceeding the second distance threshold:
flagging the second captured insight as distant from the set of stored insights represented in the set of nodes; and
discarding the second captured insight.

10. The method of claim 1:
wherein generating the proposed child node comprises:
in response to the first specificity score exceeding the second specificity score and in response to the shortest distance falling within distance a distance range between a first distance threshold and a second distance threshold, generating the proposed child node; and
further comprising:
based on the first transcript, extracting a second captured insight representing a second unit of knowledge communicated between the first user and the second user during the first video conference;
calculating a second set of distances between the second captured insight and the set of stored insights represented in the set of nodes contained in the knowledge graph;
identifying a third node, in the set of nodes in the knowledge graph, representing a third stored insight associated with a second shortest distance, in the first set of distances, to the second captured insight; and
in response to the second shortest distance falling below the first distance threshold, populating the third node with the second captured insight.

11. The method of claim 10, further comprising:
accessing a node quantity of the set of nodes contained in the knowledge graph;
setting the first distance threshold correlated with the node quantity; and
setting the second distance threshold inversely correlated with the node quantity.

12. The method of claim 1:
wherein generating the lesson based on the first captured insight, the first transcript, and the first video file comprises:
based on language concepts represented in the first transcript, identifying a set of subtopics associated with the first captured insight;
extracting a series of video segments, from the first video file, each video segment in the series of video segments containing a portion of the first video conference in which the first user and the second user discuss each subtopic, in the set of subtopics;
compiling the series of video segments into an educational video; and
generating the lesson comprising the educational video;
further comprising:
storing the educational video in a remote database; and
populating the first node with a resource locator for accessing the educational video; and
wherein serving the lesson, from the first node, to the fourth user comprises:
accessing the educational video from the remote database based on the resource locator; and
serving the educational video to the fourth user.

13. The method of claim 1:
wherein generating the lesson based on the first captured insight, the first transcript, and the first video file comprises:
converting the first transcript into a series of guided prompts configured to prompt a pair of users to discuss the first captured insight; and
generating the lesson comprising the series of guided prompts; and
further comprising:
during a third time period succeeding the first time period:
assigning the first node to a fifth user and a sixth user;
initiating a second video conference between the fifth user and the sixth user;
sequentially serving the series of guided prompts to the fifth user and the sixth user; and
recording a second audio file of the second video conference;
generating a second transcript of the second audio file;
based on the second transcript, extracting a second captured insight representing a second unit of knowledge communicated between the fifth user and the sixth user during the second video conference;
calculating a second set of distances between the second captured insight and the set of stored insights represented in the set of nodes contained in the knowledge graph;
identifying the first node representing the first captured insight associated with a second shortest distance, in the second set of distances, to the second captured insight;
characterizing a third specificity score of the second captured insight;
accessing a first specificity score of the first captured insight represented by the first node; and
in response to the third specificity score exceeding the first specificity score:
generating a second proposed child node; and
populating the second proposed child node with the second captured insight.

14. The method of claim 1, further comprising:
based on the first transcript of the first audio file, characterizing the first user as an expert user;
based on the first captured insight, identifying a first topic of the first node;
generating a second prompt associated with the first topic;
during a third time period succeeding the first time period:
serving the second prompt to the first user; and
recording a second audio file and a second video file of the first user responding to the second prompt;
generating a second transcript of the first audio file;
based on the second transcript, extracting a second captured insight representing a second unit of knowledge communicated by the first user on the first topic;
based on the second transcript, the second video file, and the second captured insight, generating a second lesson associated with the first topic; and
storing a third node in the knowledge graph, the third node descendent from the first node and populated with the second lesson and the second captured insight.

15. The method of claim 1, further comprising:
in response to a difference between the first specificity score and the second specificity score exceeding a threshold and in response to the first node and the second node comprising adjacent nodes in the knowledge graph:
based on the first captured insight and the second stored insight, generating a second prompt configured to elicit sharing of knowledge linking the second stored insight to the first captured insight;
during a third time period succeeding the first time period:
serving the second prompt to a fifth user; and
recording a second audio file of the fifth user responding to the second prompt;
generating a second transcript of the second audio file;
based on the second transcript, extracting a second captured insight;
based on the second transcript and the second captured insight, generating a second lesson associated with the second captured insight; and
inserting an intermediate node, containing the second captured insight and the second lesson, into the knowledge graph between the first node and the second node.

16. A method includes:
during a first time period, serving a first prompt to a first user and a second user, the first prompt associated with a first node in a knowledge graph;
accessing a first set of language concepts representing a discussion between the first user and the second user responsive to the first prompt;
based on the first set of language concepts, extracting a first captured insight representing a first unit of knowledge communicated between the first user and the second user in response to the first prompt;
calculating a first set of distances between the first captured insight and stored insights represented in a set of nodes contained in the knowledge graph;
identifying a second node, in the set of nodes in the knowledge graph, representing a second stored insight associated with a shortest distance, in the first set of distances, to the first captured insight;
characterizing a first specificity score of the first captured insight;
accessing a second specificity score of the second stored insight;
in response to the first specificity score exceeding the second specificity score, generating a first node descendent from the second node in the knowledge graph and populated with the first captured insight; and
in response to the shortest distance exceeding a threshold distance:
based on the first captured insight and the second stored insight, generating a second prompt configured to elicit sharing of knowledge linking the second stored insight to the first captured insight; and
during a second time period succeeding the first time period:
serving the second prompt to a third user; and
accessing a second set of language concepts representing a response of the third user to the second prompt;
based on the second set of language concepts, extracting a second captured insight; and
inserting an intermediate node, containing the second captured insight, into the knowledge graph between the first node and the second node.

17. The method of claim 16, wherein calculating the first set of distances between the first captured insight and the set of stored insights represented in the set of nodes comprises:
representing the first set of language concepts as a first embedding vector in a multidimensional vector space containing embedding vectors representing the set of stored insights represented in the set of nodes contained in the knowledge graph;
calculating a first set of Euclidean distances between the first embedding vector and the embedding vectors representing the set of stored insights represented in the set of nodes; and
mapping the first set of Euclidean distances to the first set of distances between the first captured insight and the set of stored insights represented in the set of nodes.

18. The method of claim 16:
further comprising, prior to the first time period:
accessing a second set of relative specificities of a second set of language concepts:
representing a second discussion between a fourth user and a fifth user responsive to a second prompt; and
associated with the second stored insight; and
aggregating the second set of relative specificities into the second specificity score of the second stored insight; and
wherein characterizing the first specificity score of the first captured insight comprises:
identifying a first set of relative specificities of the first set of language concepts; and
aggregating the first set of relative specificities into the first specificity score of the first captured insight.

19. A method includes:
accessing a set of language concepts representing a discussion between a first user and a second user responsive to a first prompt;
based on the set of language concepts, extracting a first captured insight representing a first unit of knowledge communicated between the first user and the second user responsive to the first prompt;
calculating a first set of distances between the first captured insight and stored insights represented in a set of nodes contained in a knowledge graph;
identifying a second node, in the set of nodes in the knowledge graph, representing a second stored insight associated with a shortest distance, in the first set of distances, to the first captured insight;
characterizing a first specificity score of the first captured insight;
accessing a second specificity score of the second stored insight;
in response to the first specificity score exceeding the second specificity score:
generating a proposed child node;
populating the proposed child node with the first captured insight;
defining the proposed child node as descendent from the second node in the knowledge graph;
serving a visual representation of the proposed child node in the knowledge graph to a third user; and
prompting the third user to confirm the proposed child node; and
in response to receiving a confirmation of the proposed child node from the third user, storing the proposed child node as a first node, descendent from the second node, in the knowledge graph.

20. The method of claim 19, further comprising:
during a second time period succeeding the first time period:
assigning the first node to a fourth user; and
in response to assigning the first node to the fourth user:
converting the set of language concepts into a training module on a topic associated with the first captured insight;
populating the first node with the training module; and
serving the training module to the fourth user; and
during a third time period succeeding the second time period:
assigning the first node to a fifth user and a sixth user; and
in response to assigning the first node to the fifth user and the sixth user:
converting the first transcript into a series of guided prompts configured to prompt a pair of users to discuss the first captured insight;
populating the first node with the series of guided prompts; and
sequentially serving the series of guided prompts to the fifth user and the sixth user.
